(19) United States
(12) Patent Application Publication
(10) Pub. No.: US 2026/0312732 A1
(43) Pub. Date: Oct. 8, 2026

(54) EARLY TERMINATION OF A HYBRID AUTOMATIC REPEAT REQUEST RE-TRANSMISSION OF A DISCONTINUOUS RECEPTION CONFIGURATION

(71) Applicant: QUALCOMM Incorporated, San Diego, CA (US)

(72) Inventors: Fang YUAN, Beijing (CN); Iyab Issam SAKHNINI, San Diego, CA (US); Yan ZHOU, San Diego, CA (US); Linhai HE, San Diego, CA (US); Tao LUO, San Diego, CA (US); Junyi LI, Greentown, PA (US)

(21) Appl. No.: 18/996,854

(22) PCT Filed: Sep. 30, 2022
(86) PCT No.: PCT/CN2022/123069

§ 371 Date: Jan. 17, 2025

(51) Int. Cl. H04L 1/1607; H04L 5/00; H04W 52/02

(52) U.S. Cl. CPC H04L 1/1671; H04L 5/0055; H04W 52/0212

(57) ABSTRACT

Various aspects of the present disclosure generally relate to wireless communication. In some aspects, a user equipment (UE) may receive downlink control information (DCI) comprising a downlink feedback indicator (DFI) field indicative of at least one DFI value. The UE may terminate a hybrid automatic repeat request (HARQ) re-transmission operation associated with a discontinuous reception cycle based on receiving the DCI. The UE may transition from a first state to a second state based on terminating the HARQ re-transmission operation, wherein the second state comprises a power-saving state. Numerous other aspects are described.

### INTRODUCTION

Aspects of the present disclosure generally relate to wireless communication and to techniques and apparatuses for discontinuous reception.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The user equipment may include a memory and one or more processors coupled to the memory. The one or more processors may be configured to receive downlink control information (DCI) comprising a downlink feedback indicator (DFI) field indicative of at least one DFI value. The one or more processors may be configured to terminate a hybrid automatic repeat request (HARQ) re-transmission operation associated with a discontinuous reception cycle based on receiving the DCI. The one or more processors may be configured to transition from a first state to a second state based on terminating the HARQ re-transmission operation, wherein the second state comprises a power-saving state.

Some aspects described herein relate to a network node for wireless communication. The network node may include a memory and one or more processors coupled to the memory. The one or more processors may be configured to transmit configuration information indicative of a DFI field of a DCI format. The one or more processors may be configured to transmit DCI corresponding to the DCI format, wherein the DCI comprises the DFI field, wherein the DFI field is indicative of at least one DFI value indicating that a UE is to terminate a HARQ re-transmission operation associated with a discontinuous reception cycle, wherein the configuration information indicates that the UE is to transition from a first state to a second state based on termination of the HARQ re-transmission operation, wherein the second state comprises a power-saving state.

Some aspects described herein relate to a method of wireless communication performed by an apparatus at a UE. The method may include receiving DCI comprising a DFI field indicative of at least one DFI value. The method may include terminating a HARQ re-transmission operation associated with a discontinuous reception cycle based on receiving the DCI. The method may include transitioning from a first state to a second state based on terminating the HARQ re-transmission operation, wherein the second state comprises a power-saving state.

Some aspects described herein relate to a method of wireless communication performed by an apparatus at a network node. The method may include transmitting configuration information indicative of a DFI field of a DCI format. The method may include transmitting DCI corresponding to the DCI format, wherein the DCI comprises the DFI field, wherein the DFI field is indicative of at least one DFI value indicating that a UE is to terminate a HARQ re-transmission operation associated with a discontinuous reception cycle, wherein the configuration information indicates that the UE is to transition from a first state to a second state based on termination of the HARQ re-transmission operation, wherein the second state comprises a power-saving state.

Some aspects described herein relate to a non-transitory computer-readable medium that stores a set of instructions for wireless communication by a UE. The set of instructions, when executed by one or more processors of the UE, may cause the UE to receive DCI comprising a DFI field indicative of at least one DFI value. The set of instructions, when executed by one or more processors of the UE, may cause the UE to terminate a HARQ re-transmission operation associated with a discontinuous reception cycle based on receiving the DCI. The set of instructions, when executed by one or more processors of the UE, may cause the UE to transition from a first state to a second state based on terminating the HARQ re-transmission operation, wherein the second state comprises a power-saving state.

Some aspects described herein relate to a non-transitory computer-readable medium that stores a set of instructions for wireless communication by a network node. The set of instructions, when executed by one or more processors of the network node, may cause the network node to transmit configuration information indicative of a DFI field of a DCI format. The set of instructions, when executed by one or more processors of the network node, may cause the network node to transmit DCI corresponding to the DCI format, wherein the DCI comprises the DFI field, wherein the DFI field is indicative of at least one DFI value indicating that a UE is to terminate a HARQ retransmission operation associated with a discontinuous reception cycle, wherein the configuration information indicates that the UE is to transition from a first state to a second state based on termination of the HARQ re-transmission operation, wherein the second state comprises a power-saving state.

Some aspects described herein relate to an apparatus for wireless communication. The apparatus may include means for receiving DCI comprising a DFI field indicative of at least one DFI value. The apparatus may include means for terminating a HARQ re-transmission operation associated with a discontinuous reception cycle based on receiving the DCI. The apparatus may include means for transitioning from a first state to a second state based on terminating the HARQ retransmission operation, wherein the second state comprises a power-saving state.

Some aspects described herein relate to an apparatus for wireless communication. The apparatus may include means for transmitting configuration information indicative of a DFI field of a DCI format. The apparatus may include means for transmitting DCI corresponding to the DCI format, wherein the DCI comprises the DFI field, wherein the DFI field is indicative of at least one DFI value indicating that a UE is to terminate a HARQ re-transmission operation associated with a discontinuous reception cycle, wherein the configuration information indicates that the UE is to transition from a first state to a second state based on termination of the HARQ re-transmission operation, wherein the second state comprises a power-saving state.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example diseggregated base station architecture, in accordance with the present disclosure.

FIG. 4 is as diagram illustrating an example associated with a discontinuous reception (DRX) configuration, in accordance with the present disclosure.

FIG. 5 is a diagram illustrating an example associated with communication of extended reality (XR) traffic, in accordance with the present disclosure.

FIG. 6 is a diagram illustrating an example associated with early termination of a hybrid automatic repeat request (HARQ) re-transmission operation, in accordance with the present disclosure.

FIG. 7 is a diagram illustrating an example of early termination of a HARQ retransmission operation, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram illustrating an example of a hardware implementation for an apparatus employing a processing system, in accordance with the present disclosure.

FIG. 12 is a diagram illustrating an example of an implementation of code and circuitry for an apparatus, in accordance with the present disclosure.

FIG. 13 is a diagram of an example apparatus for wireless communication, in accordance with the present disclosure.

FIG. 14 is a diagram illustrating an example of a hardware implementation for an apparatus employing a processing system, in accordance with the present disclosure.

FIG. 15 is a diagram illustrating an example of an implementation of code and circuitry for an apparatus, in accordance with the present disclosure.

### DETAILED DESCRIPTION

In some aspects, a user equipment (UE) may communicate in accordance with a discontinuous reception (DRX) configuration. A DRX configuration may be associated with a DRX cycle. A DRX cycle may include a DRX on duration (e.g., during which a UE is awake or in an active state) and an opportunity to enter a DRX sleep state. As used herein, the time during which the UE is configured to be in an active state, including the DRX on duration, may be referred to as a DRX active time, and the time during which the UE is configured to be in the DRX sleep state may be referred to as an inactive time. A UE may monitor a physical downlink control channel (PDCCH) during the DRX active time, and may refrain from monitoring the PDCCH during the inactive time. For example, the UE may monitor the PDCCH for downlink control information (DCI) pertaining to the UE. If the UE does not detect and/or successfully decode any PDCCH communications intended for the UE during the DRX on duration, then the UE may enter the sleep state (e.g., for the inactive time) at the end of the DRX on duration. In this way, the UE may conserve battery power and reduce power consumption. The DRX cycle may repeat with a configured periodicity according to the DRX configuration.

If the UE detects and/or successfully decodes a PDCCH communication intended for the UE, then the UE may remain in an active state (e.g., awake) for the duration of a DRX inactivity timer (IAT) (e.g., which may extend the DRX active time). The duration of the DRX IAT may be referred to as a DRX IAT duration. The DRX IAT duration may include a DRX HARQ re-transmission timer and/or a DRX retransmission timer. During the DRX IAT duration, the UE may remain in an active state to monitor for re-transmissions.

In some cases, some communications may be received in a semi-persistent manner. Semi-persistent communication configurations are configurations associated with semi-persistent communications. Semi-persistent communications are communications that are configured such that more than one configured communication can occur without requiring activation and/or dynamic scheduling of each communication. For example, in semi-persistent communications, two or more semi-persistent communication occasions may be configured so that, once the semi-persistent communication configuration is activated, a communication may occur during each of the two or more semi-persistent communications. In some aspects, semi-persistent communication configurations may include semi-persistent scheduling (SPS) configurations and configured grant (CG) configurations.

One example of a semi-persistent communication is an extended reality (XR) communication. “XR” is a term referring to real-and-virtual combined environments and human-machine interactions generated by computer technology and wearables. For example, an XR environment may be used to implement a metaverse scene or network. Non-exhaustive examples of XR include augmented reality, mixed reality, and virtual reality. XR may involve some amount of network communication. An XR communication is a transmission or series of transmissions (e.g., a traffic flow) associated with an XR application, such as a traffic flow carrying XR data. The XR application may be implemented on a network node such as an XR device and/or a UE, among other examples. An XR device may include, for example, an XR headset, a laptop, a personal computer, a gaming console, and/or a UE, among other examples. In some implementations, some amount of processing may be performed at a server, such as to generate a scene (e.g., frame) which is communicated to the XR device via a traffic burst. A traffic burst may include one or more packets and may be associated with a scene (e.g., frame) of an XR application. For example, a traffic burst may carry the data associated with the scene (e.g., frame). As another example, a network node may access data stored remotely for use in an XR environment. In some cases, an XR communication may be associated with multiple traffic flows, such as a video traffic flow, an audio traffic flow, and a haptic traffic flow.

Some periodic communications, such as XR communications, may be inherently variable. For example, XR communications may be associated with variability in the number of packets per traffic burst and in the size of each packet. XR communications also may be associated with non-integer periods. As another example, the arrival times of XR traffic may vary due to jitter and may not correspond to expected arrival times. Jitter is a variation or uncertainty in the arrival time of a communication, such as an expected or observed deviation of an actual arrival time of a packet relative to a scheduled arrival time of the packet. As still another example, multiple traffic flows of XR communications may have variable parameters and characteristics, such as different data rates, different latency or reliability requirements, different packet sizes, and so on.

In some cases, limited packet delay budgets (PDBs) can be established for XR video frames (e.g., for AR/VR, a delay budget can be 10 ms from the time when the video frame arrives at the network node to the time it is successfully transferred to the UE). Jitter and variable frame size can be better accommodated using certain dynamic signaling (e.g., wake-up signals and/or scheduling DCI, among other examples) to indicate data arrival times and number of slots with physical data communication channels for transmitting the data.

An early burst arrival, at a network node, of XR data (e.g., an arrival of XR data near a first end of a jitter distribution) may result in increased delay at a buffer (e.g., a downlink buffer) relative to a just in time burst arrival since the physical data communication channel scheduled for transmitting the data associated with the burst can occur adjacent to an expected arrival time, near the center of the jitter distribution. In some cases, the early burst arrival can occur outside of a DRX on duration, which can result in delayed reception of the XR data. A late burst arrival (which can occur outside of a DRX on duration) can result in latency within the PDB as well as inefficient consumption of power resources prior to the arrival. A DRX retransmission timer can be started after arrival of a burst at a UE. Once the DRX retransmission timer is started, the UE monitors the PDCCH, based on a HARQ process, according to the configuration even if the network does not intend to schedule a retransmission, which can result in an unnecessary consumption of power by the UE. With deadline-aware scheduling, some HARQ re-transmissions may be not able to be scheduled before the burst deadline, which also can result in an unnecessary consumption of power by the UE.

Some techniques described herein provide for early termination of a HARQ retransmission operation associated with a DRX based on receiving a DCI containing a DFI that is configured for downlink and/or uplink early HARQ termination for power saving purposes in scenarios involving variable communication times such as XR communications. For example, in some aspects, a UE may receive DCI that includes a DFI field indicative of a DFI value. The UE may terminate a HARQ re-transmission operation based on receiving the DCI. The UE may transition from a first state to a second state based on terminating the HARQ re-transmission operation, where the second state is a power-saving state. In some aspects, the UE may terminate the HARQ re-transmission operation by ending a HARQ re-transmission timer and/or by flushing a HARQ buffer corresponding to the HARQ re-transmission operation. In this way, some aspects described herein may facilitate terminating a HARQ re-transmission operation before an end of the DRX active time, thereby improving resource allocation efficiency and decreasing power consumption by the UE. As a result, some aspects may facilitate XR-specific power savings and resource allocation, which may decrease jitter and/or latency, while increasing reliability.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

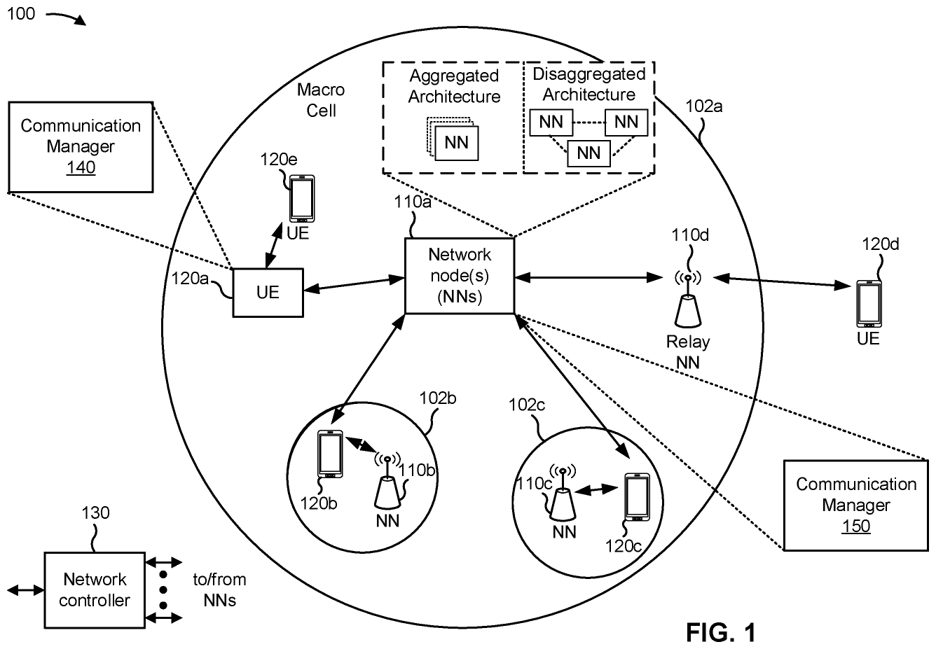

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a di saggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive DCI comprising a DFI field indicative of at least one DFI value; terminate a HARQ retransmission operation associated with a DRX cycle based on receiving the DCI; and transition from a first state to a second state based on terminating the HARQ retransmission operation, wherein the second state comprises a power-saving state.

Additionally, or alternatively, the communication manager 140 may perform one or more other operations described herein.

In some aspects, the network node 110 may include a communication manager 150. As described in more detail elsewhere herein, the communication manager 150 may transmit configuration information indicative of a DFI field of a DCI format; and transmit DCI corresponding to the DCI format, wherein the DCI comprises the DFI field, wherein the DFI field is indicative of at least one DFI value indicating that a UE 120 is to terminate a HARQ re-transmission operation associated with a DRX cycle, wherein the configuration information indicates that the UE is to transition from a first state to a second state based on termination of the HARQ re-transmission operation, wherein the second state comprises a power-saving state. Additionally, or alternatively, the communication manager 150 may perform one or more other operations described herein.

As indicated above, FIG. 1 is provided as an example. Other examples may differ from what is described with regard to FIG. 1.

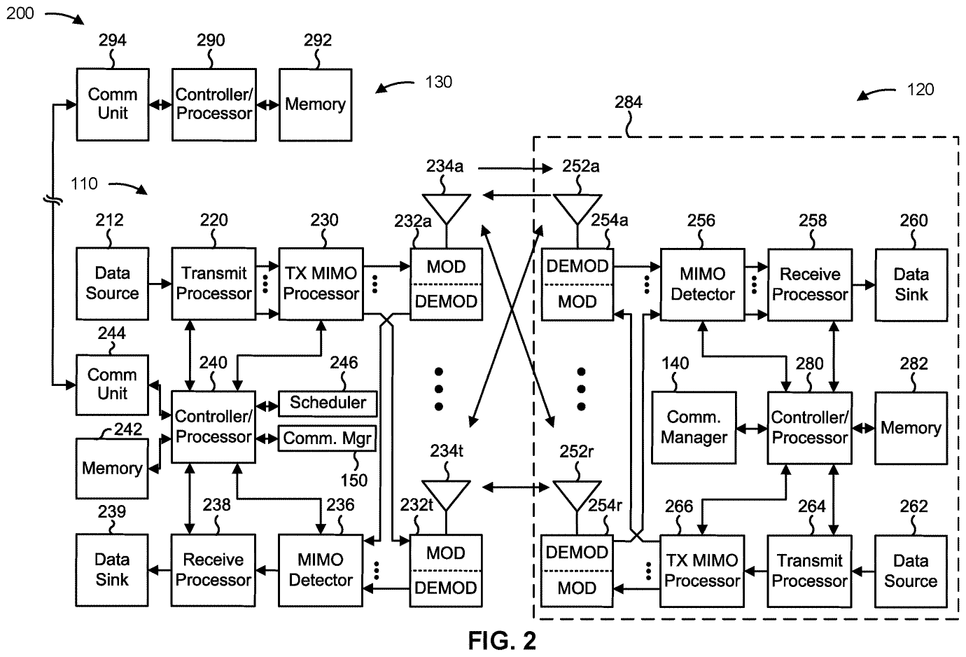

FIG. 2 is a diagram illustrating an example 200 of a network node 110 in communication with a UE 120 in a wireless network 100, in accordance with the present disclosure. The network node 110 may be equipped with a set of antennas 234a through 234t, such as Tantennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream.

Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a base station, such as for millimeter wave communications and/or the like. In such a case, the base station may provide the UE with a configuration of transmission configuration indicator (TCI) states that respectively indicate beams that may be used by the UE, such as for receiving a physical downlink shared channel (PDSCH). The base station may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a quasi-co-location (QCL) type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) DCI to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

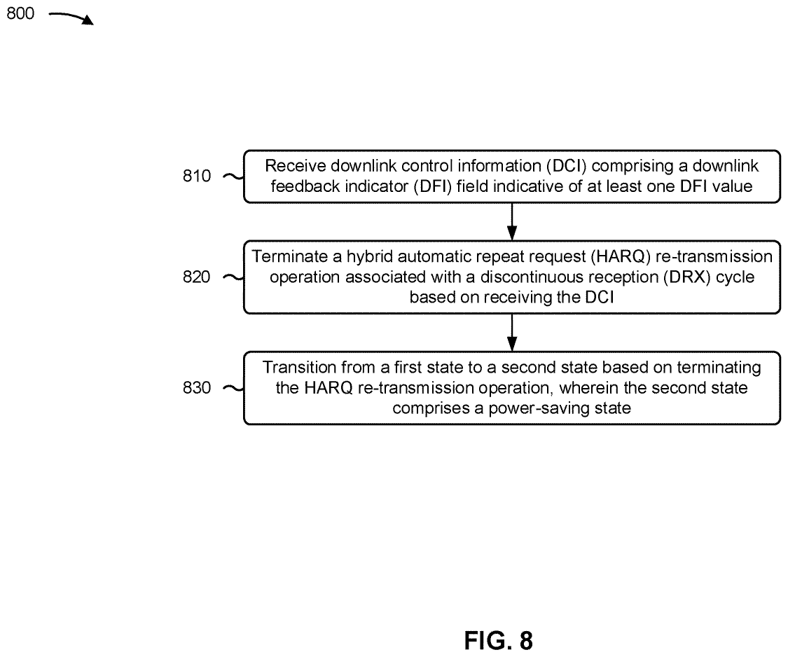

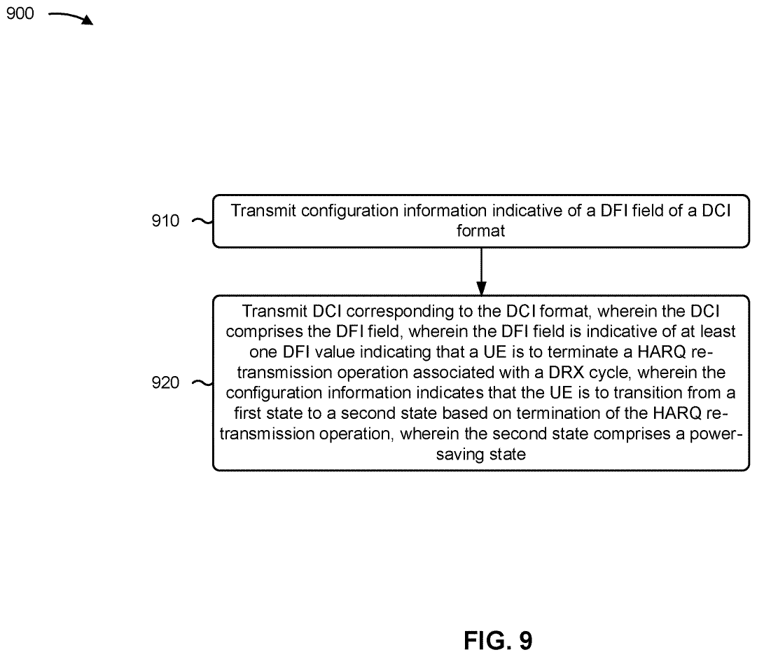

The controller/processor 240 of the network node 110, the controller/processor 280 of the UE 120, and/or any other component(s) of FIG. 2 may perform one or more techniques associated with early termination of hybrid automatic repeat request re-transmissions, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving DCI comprising a DFI field indicative of at least one DFI value; means for terminating a HARQ retransmission operation associated with a discontinuous reception cycle based on receiving the DCI; and/or means for transitioning from a first state to a second state based on terminating the HARQ re-transmission operation, wherein the second state comprises a power-saving state. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting configuration information indicative of a DFI field of a DCI format; and/or means for transmitting DCI corresponding to the DCI format, wherein the DCI comprises the DFI field, wherein the DFI field is indicative of at least one DFI value indicating that a UE 120 is to terminate a HARQ re-transmission operation associated with a discontinuous reception cycle, wherein the configuration information indicates that the UE 120 is to transition from a first state to a second state based on termination of the HARQ retransmission operation, wherein the second state comprises a power-saving state. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

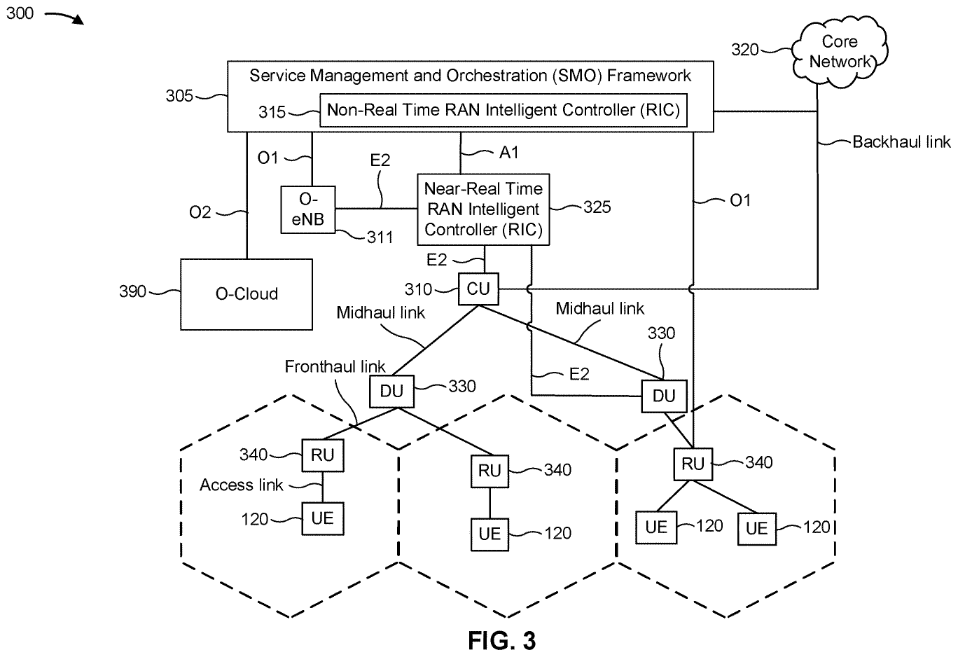

FIG. 3 is a diagram illustrating an example di saggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective RF access links.

In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

As indicated above, FIG. 3 is provided as an example. Other examples may differ from what is described with regard to FIG. 3.

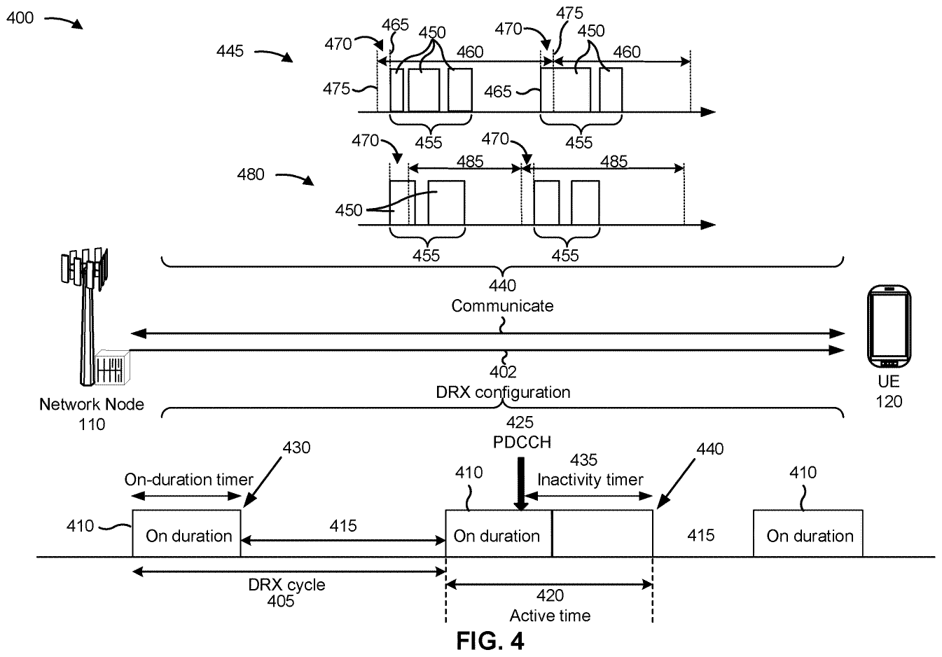

FIG. 4 is as diagram illustrating an example 400 associated with a DRX configuration, in accordance with the present disclosure. As shown by reference number 402, a network node 110 may transmit a DRX configuration to a UE 120 to configure a DRX cycle 405 for the UE 120. A DRX cycle 405 may include a DRX on duration 410 (e.g., during which a UE 120 is awake or in an active state) and an opportunity to enter a DRX sleep state 415. As used herein, the time during which the UE 120 is configured to be in an active state, including the DRX on duration 410, may be referred to as a DRX active time 420, and the time during which the UE 120 is configured to be in the DRX sleep state 415 may be referred to as an inactive time. As described below, the UE 120 may monitor a PDCCH during the DRX active time 420, and may refrain from monitoring the PDCCH during the inactive time.

During the DRX on duration 410, the UE 120 may monitor a downlink control channel (e.g., a PDCCH), as shown by reference number 425. For example, the UE 120 may monitor the PDCCH for DCI pertaining to the UE 120. If the UE 120 does not detect and/or successfully decode any PDCCH communications intended for the UE 120 during the DRX on duration 410, then the UE 120 may enter the sleep state 415 (e.g., for the inactive time) at the end of the DRX on duration 410, as shown by reference number 430. In this way, the UE 120 may conserve battery power and reduce power consumption. As shown, the DRX cycle 405 may repeat with a configured periodicity according to the DRX configuration.

If the UE 120 detects and/or successfully decodes a PDCCH communication intended for the UE 120, then the UE 120 may remain in an active state (e.g., awake) for the duration of a DRX IAT 435 (e.g., which may extend the DRX active time 420). The duration of the DRX IAT 435 may be referred to as a DRX IAT duration. The DRX IAT duration 435 may include a DRX HARQ re-transmission timer and/or a DRX re-transmission timer. The UE 120 may start the DRX IAT 435 at a time at which the PDCCH communication is received (e.g., in a transmission time interval (TTI) in which the PDCCH communication is received, such as a slot or a subframe). The UE 120 may remain in the active state until the DRX IAT 435 expires, at which time the UE 120 may enter the sleep state 415 (e.g., for the inactive time), as shown by reference number 440. During the duration of the DRX IAT 435, the UE 120 may continue to monitor for PDCCH communications, may obtain a downlink data communication (e.g., on a downlink data channel, such as a PDSCH) scheduled by the PDCCH communication, and/or may prepare and/or transmit an uplink communication (e.g., on a physical uplink shared channel (PUSCH)) scheduled by the PDCCH communication. The UE 120 may restart the DRX IAT 435 after each detection of a PDCCH communication for the UE 120 for an initial transmission (e.g., but not for a retransmission).

As shown by reference number 440, the UE 120 and network node 110 may communicate with one another. The communication may involve XR communications. Some periodic communications, such as XR communications, may be inherently variable. For example, as shown in connection with a first XR traffic flow 445, XR communications may be associated with variability in the number of packets 450 per traffic burst 455 and in the size of each packet 450. XR communications also may be associated with non-integer periods 460 (e.g., 1/60 frames per second=16.67 ms period and 1/120 fps=8.33 ms period). As another example, the arrival times 465 of XR traffic may vary due to jitter 470 and may not correspond to expected arrival times 475. Jitter is a variation or uncertainty in the arrival time of a communication, such as an expected or observed deviation of an actual arrival time of a packet relative to a scheduled arrival time of the packet. As still another example, multiple traffic flows of XR communications may have variable parameters and characteristics, such as different data rates, different latency or reliability requirements, different packet sizes, and so on. For example, as shown, a second XR traffic flow 480 may have a different number of packets 450 per traffic burst 455 and a different non-integer period 485, which may result in jitter 470 that is different from that of the first XR traffic flow 445.

As indicated above, FIG. 4 is provided as an example. Other examples may differ from what is described with regard to FIG. 4.

In some cases, limited PDBs can be established for XR video frames (e.g., for AR/VR, a delay budget can be 10 ms from the time when the video frame arrives at the network node to the time it is successfully transferred to the UE). Jitter and variable frame size can be better accommodated using certain dynamic signaling (e.g., wake-up signals and/or scheduling DCI, among other examples) to indicate data arrival times and number of slots with physical data communication channels for transmitting the data.

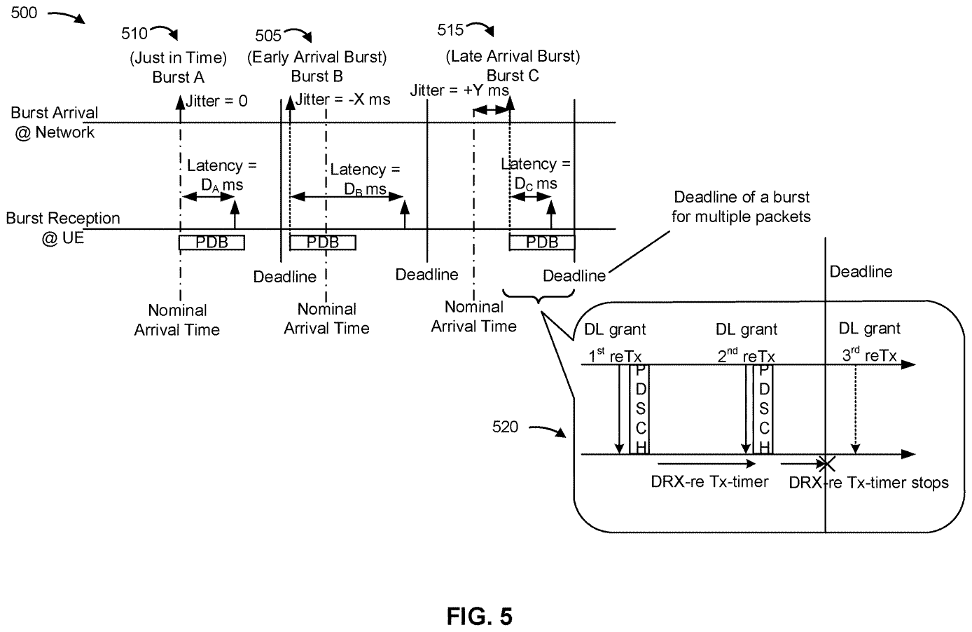

FIG. 5 is a diagram illustrating an example 500 associated with communication of XR traffic, in accordance with the present disclosure.

As shown by reference number 505, an early burst arrival, at a network node, of XR data (e.g., an arrival of XR data near a first end of a jitter distribution) may result in increased delay at a buffer (e.g., a downlink buffer) relative to a just in time burst arrival (shown at reference number 510) since the physical data communication channel scheduled for transmitting the data associated with the burst can occur adjacent to an expected arrival time, near the center of the jitter distribution. In some cases, the early burst arrival can occur outside of a DRX on duration, which can result in delayed reception of the XR data. As shown by reference number 515, a late burst arrival (which can occur outside of a DRX on duration) can result in latency within the PDB as well as inefficient consumption of power resources prior to the arrival.

As shown by reference number 520, a DRX retransmission timer can be started after arrival of a burst at a UE. Once the DRX retransmission timer is started, the UE monitors the PDCCH, based on a HARQ process, according to the configuration even if the network does not intend to schedule a retransmission, which can result in an unnecessary consumption of power by the UE. With deadline-aware scheduling, some HARQ re-transmissions may be not able to be scheduled before the burst deadline, which also can result in an unnecessary consumption of power by the UE.

In some cases, a DFI indication can be used to facilitate configured grant operation. For example, a UE can be configured with a number of search space sets to monitor PDCCH for detecting a DCI format 0_1 with a DFI flag field and a cyclic redundancy check (CRC) scrambled with a configured scheduling (CS)-radio network temporary identifier (RNTI) provided by cs-RNTI. The UE can determines that the DCI format provides HARQ-ACK information for PUSCH transmissions based on when a DFI flag field value is set to ‘1’, if a PUSCH transmission is configured by ConfiguredGrantConfig. For an initial transmission by a UE of a transport block in a PUSCH configured by ConfiguredGrantConfig, if the UE receives a CG-DFI that provides HARQ-ACK information for the transport block, the UE can assume that the transport block was correctly decoded if the HARQ-ACK information value is ACK; otherwise, the UE can assume that the transport block was not correctly decoded. For a PUSCH transmission scheduled by a DCI format, if the UE receives a CG-DFI that provides HARQ-ACK information for the transport block, the UE can assume that the transport block was correctly decoded if the HARQ-ACK information value is ACK; otherwise, the UE can assume that the transport block was not correctly decoded.

Some techniques described herein provide for early termination of a HARQ retransmission operation associated with a DRX based on receiving a DCI containing a DFI that is configured for downlink and/or uplink early HARQ termination for power saving purposes in scenarios involving variable communication times such as XR communications. For example, in some aspects, a UE may receive DCI that includes a DFI field indicative of a DFI value. The UE may terminate a HARQ re-transmission operation based on receiving the DCI. The UE may transition from a first state to a second state based on terminating the HARQ re-transmission operation, where the second state is a power-saving state. In some aspects, the UE may terminate the HARQ re-transmission operation by ending a HARQ re-transmission timer and/or by flushing a HARQ buffer corresponding to the HARQ re-transmission operation. In this way, some aspects described herein may facilitate terminating a HARQ re-transmission operation before an end of the DRX active time, thereby improving resource allocation efficiency and decreasing power consumption by the UE. As a result, some aspects may facilitate XR-specific power savings and resource allocation, which may decrease jitter and/or latency, while increasing reliability.

In some aspects, for example, a UE may be configured with a DFI field in a DCI format to end a HARQ retransmission in a DRX cycle for power saving purpose.

The DCI format may be a downlink DCI format 1_1 and/or an uplink DCI format 0_1, and may be scrambled by a cell-RNTI (C-RNTI), a CS-RNTI, and/or an MCS-RNTI. If the DCI is a downlink DCI, the DCI may include a DFI flag field and a field including a HARQ-ACK bitmap. The HARQ-ACK bitmap may include 16 or 32 bits, subject to UE capability. In some aspects, all of the remaining bits may be set to zero. If the DCI is an uplink DCI, the DCI may include a DFI flag field and a field including a HARQ-ACK bitmap having 16 bits. In some aspects, all of the remaining bits may be set to zero. The order of the bitmap to HARQ process index mapping may be configured such that HARQ process indices are mapped in ascending order from most significant bit (MSB) to least significant bit (LSB) of the bitmap.

In some aspects, for example, when a UE receives a DCI with a DFI flag field set as 1, for each bit of the bitmap, a value 1 indicates ACK, which means the corresponding HARQ retransmissions may be ended for power saving, (e.g., by ending a HARQ retransmission timer and ending a retransmission timer in a DRX cycle and/or by flushing a HARQ buffer). In some aspects, the UE may terminate a timer after a configured and/or indicated quantity, X, symbols from the DCI. In some aspects, a value 0 in the bitmap may indicate a NACK, and the UE may refrain from terminating the HARQ re-transmission operation early based on the NACK.

Some aspects described herein may be implemented based on a rule that indicates that for a PDSCH transmission scheduled by a DCI format, or for an initial transmission by a UE of a transport block in a PDSCH configured by SPSConfig, if the UE receives a DFI that provides ACK information for the transport block, the UE may flush the buffer for the transport block; otherwise, the UE may not flush the buffer for the transport block. In some aspects, the rule may indicate that for a PUSCH transmission scheduled by a DCI format or for an initial transmission by a UE of a transport block in a PUSCH configured by ConfiguredGrantConfig, if the UE receives a DFI that provides ACK information for the transport block, the UE may flush the buffer for the transport block; otherwise, the UE may not flush the buffer for the transport block.

As indicated above, FIG. 5 is provided as an example. Other examples may differ from what is described with regard to FIG. 5.

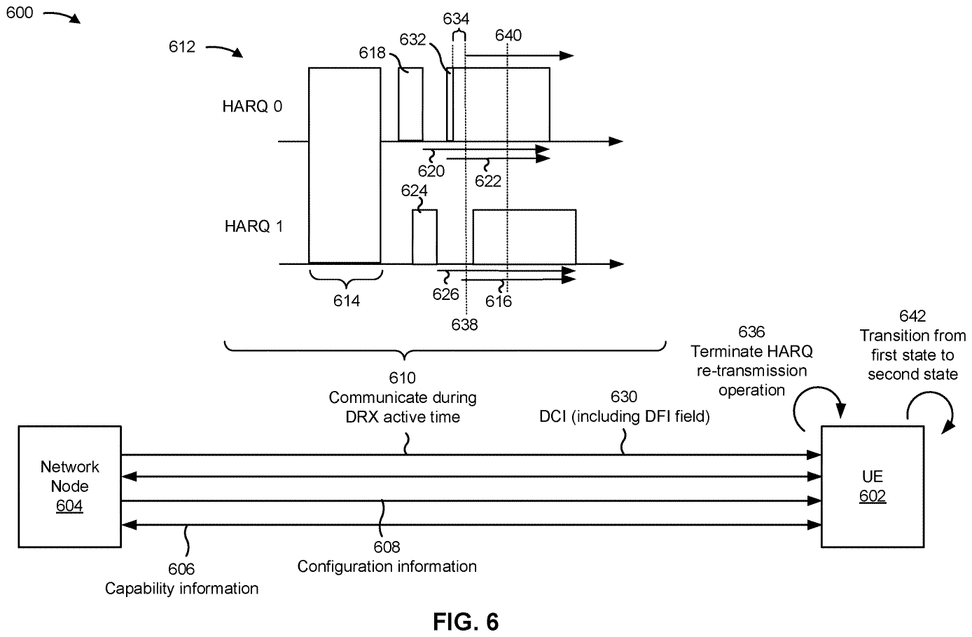

FIG. 6 is a diagram illustrating an example 600 associated with early termination of a HARQ re-transmission operation, in accordance with the present disclosure. As shown in FIG. 6, a UE 602 and a network node 604 may communicate with one another. In some aspects, the UE 602 may be, be similar to, include, or be included in, the UE 120 depicted in FIGS. 1-3. In some aspects, the network node 604 may be, be similar to, include, or be included in, the network node 110 depicted in FIGS. 1 and 2 and/or one or more components of the disaggregated base station architecture 300 depicted in FIG. 3.

As shown by reference number 606, the UE 602 may transmit, and the network node 604 may receive, capability information. The capability information may be indicative of one or more capabilities of the UE 602. For example, the capability information may indicate a capability of the UE 602 for receiving and decoding a HARQ bitmap having an indicated quantity of bits (e.g., 16 bits and/or 32 bits, among other examples). In some aspects, the capability information may be indicative of a capability of the UE 602 to receive a DFI.

As shown by reference number 608, the network node 604 may transmit, and the UE 602 may receive, configuration information. In some aspects, the configuration information may be carried in an RRC message. The configuration information may include a DRX configuration. In some aspects, the configuration information may indicate a configuration for a DFI field in DCI. In some aspects, the configuration information may be indicative of a set of potential time offset values associated with termination of a HARQ re-transmission operation based on receiving a DFI. For example, a time offset value may correspond to a time period between receiving the DFI and transitioning from a first state to a second state. In some aspects, a DCI transmission may indicate a time offset of a set of potential time offset values.

As shown by reference number 610, the UE 602 and the network node 604 may communicate with one another during a DRX active time corresponding to the DRX configuration. In some aspects, the UE 602 and the network node 604 may communicate XR data during the DRX active time. Communicating may refer to transmitting and/or receiving signals. As shown by the schematic representation 612, the DRX active time may include a time period starting at a start of a DRX on duration 614 and ending at an expiration of a DRX re-transmission timer duration 616.

As shown, a first transport block 618 associated with a first HARQ process (shown as “HARQ 0”) may be received during the DRX active time. Based on reception of the first transport block 618, the UE 602 may start a DRX HARQ retransmission timer duration 620 and, after a configured offset, the UE 602 may start a DRX re-transmission timer duration 622, which may run serially after the DRX HARQ re-transmission timer duration 620 or at least partially concurrently with the DRX HARQ re-transmission timer duration 620. Similarly, a second transport block 624 associated with a second HARQ process (shown as “HARQ 1”) may be received during the DRX active time. Based on reception of the first transport block 618, the UE 602 may start a DRX HARQ re-transmission timer duration 626 and, after a configured offset, the UE 602 may start the DRX re-transmission timer duration 616, which may run serially after the DRX HARQ re-transmission timer duration 626 or at least partially concurrently with the DRX HARQ re-transmission timer duration 626. During the DRX re-transmission timer durations 622 and 616, the UE 602 may be active to receive a grant (e.g., for a re-transmission) associated with the respective HARQ process.

As shown by reference number 630, the network node 604 may transmit, and the UE 602 may receive, DCI 632 including a DFI field. The DFI field may be indicative of at least one DFI value. In some aspects, the DCI 632 may correspond to a downlink DCI format 1_1 or a downlink DCI format 0_1. In some aspects, the DCI may be scrambled by a C-RNTI, a CS-RNTI, or an MCS-RNTI. In some aspects, the DFI field may include a DFI flag field and a HARQ-ACK bitmap. Any bit not associated with either the DFI field or the HARQ-ACK bitmap may be set to 0.

In some aspects, the DCI 632 may correspond to a downlink DCI format and the HARQ-ACK bitmap may include 16 bits or 32 bits. In some aspects, the DCI 632 may correspond to an uplink DCI format and the HARQ-ACK bitmap may include 16 bits. In some aspects, an order associated with a mapping between a plurality of bits of the HARQ-ACK bitmap and a plurality of HARQ process indices may include an ascending order from an MSB of the bitmap to an LSB of the bitmap. In some aspects, the DFI flag field may include a first value, and a bit of the HARQ-ACK bitmap that indicates the first value may be indicative of an ACK. In some aspects, whether to perform the HARQ re-transmission operation corresponds to the bit of the HARQ-ACK bitmap. In some aspects, the DCI 632 also may be indicative of an offset 634 associated with terminating one or more HARQ re-transmission operations.

As shown by reference number 636, the UE 602 may terminate a HARQ retransmission operation. The HARQ re-transmission operation may be associated with a DRX cycle and may be terminated, at a termination time 638, based on receiving the DCI 632. As shown, the termination time 638 may occur prior to a burst deadline 640. In some aspects, the UE 602 may terminate the HARQ re-transmission operation based on ending a HARQ re-transmission timer 622 and/or 616. In some aspects, the UE 602 may terminate the HARQ re-transmission operation based on flushing a HARQ buffer corresponding to the HARQ re-transmission operation.

In some aspects, the DFI may correspond to only one connected mode DRX (CDRX) cycle. For example, the DCI 632 may include only one bit that indicates the DFI. In some aspects, the DFI may correspond to a plurality of CDRX cycles. For example, the DCI 632 may correspond to an indicated DCI format (e.g., DCI format 1_1 and/or DCI format 0_1), and the DFI may include a bitmap having a size equal to a number of CDRX groups associated with a configured set of CDRX groups. Each group may correspond to one or more CCs and/or HARQ processes. In some aspects, the bitmap may include a plurality of bits, each bit of the plurality of bits corresponding to a CDRX group of the configured set of CDRX groups. A first value (e.g., ‘0’) of a bit of the plurality of bits may indicate that a corresponding CDRX group is to stay active, and a second value (e.g., ‘1’) of the bit may indicate that the corresponding CDRX group is to terminate a HARQ retransmission operation associated with the CDRX group.

As shown by reference number 642, the UE 602 may transition from a first state to a second state. The UE 602 may transition from the first state to the second state based on terminating the HARQ re-transmission operation. The second state may include a power-saving state in which one or more components of the UE 602 are in a sleep state (e.g., deactivated).

As indicated above, FIG. 6 is provided as an example. Other examples may differ from what is described with regard to FIG. 6.

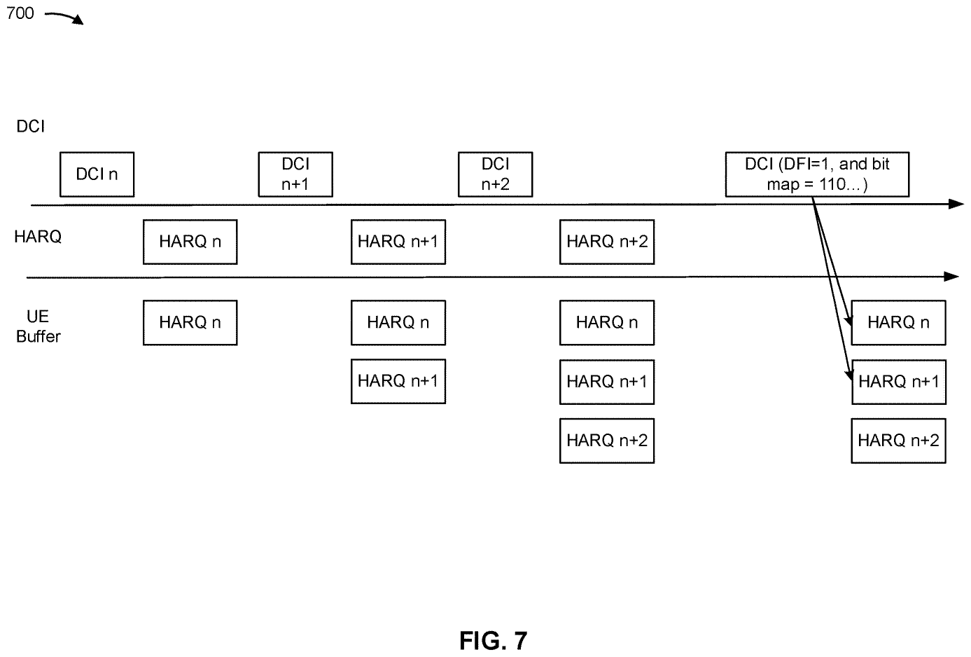

FIG. 7 is a diagram illustrating an example 700 of early termination of a HARQ re-transmission operation, in accordance with the present disclosure. As shown, a number of DCI transmissions (shown as “DCI n,” “DCI n+1,” and “DCI n+2”) may be received. Based on each DCI transmission being received, a respective HARQ process (shown as “HARQ n,” “HARQ n+1,” and “HARQ n+2”) may be triggered, causing a corresponding HARQ-ACK/NACK to be stored in a HARQ buffer. As shown, the HARQ buffer may be aggregated at each HARQ process occurrence, resulting in the buffer including all three (or more) HARQ-ACKs/NACKs after triggering the third HARQ process, HARQ n+2. As shown, DCI including a DFI having a value of 1 may be received and, based on receiving the DCI, the UE may flush the corresponding HARQ buffer. In the example, the DFI indicates a DFT value of 1, and a bit map 110 mapped for the HARQ n, n+1, and n+2, the UE may flush the HARQ n and n+1, and maintain the HARQ n+2. In this way, the UE may preserve power resources subsequent to receiving the DCI by removing bits from a buffer since the maintenance of the bits within the buffer may result in consumption of power resources.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 602) performs operations associated with early termination of a HARQ re-transmission.

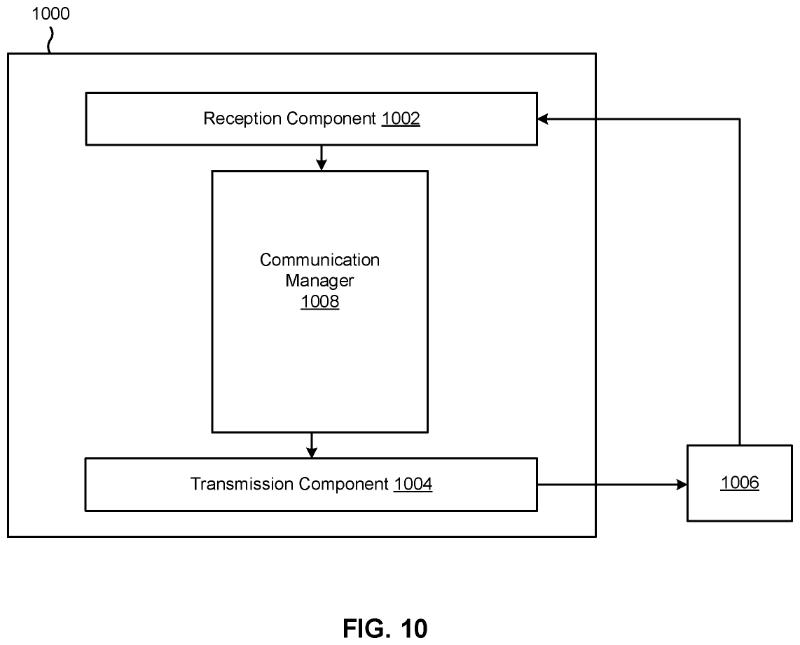

As shown in FIG. 8, in some aspects, process 800 may include receiving DCI comprising a DFI field indicative of at least one DFI value (block 810). For example, the UE (e.g., using communication manager 1008 and/or reception component 1002, depicted in FIG. 10) may receive DCI comprising a DFI field indicative of at least one DFI value, as described above.

As further shown in FIG. 8, in some aspects, process 800 may include terminating a HARQ re-transmission operation associated with a discontinuous reception cycle based on receiving the DCI (block 820). For example, the UE (e.g., using communication manager 1008, reception component 1002, and/or transmission component 1004, depicted in FIG. 10) may terminate a HARQ re-transmission operation associated with a discontinuous reception cycle based on receiving the DCI, as described above.

As further shown in FIG. 8, in some aspects, process 800 may include transitioning from a first state to a second state based on terminating the HARQ retransmission operation, wherein the second state comprises a power-saving state (block 830). For example, the UE (e.g., using communication manager 1008, reception component 1002, and/or transmission component 1004, depicted in FIG. 10) may transition from a first state to a second state based on terminating the HARQ retransmission operation, wherein the second state comprises a power-saving state, as described above.

Process 800 may include additional aspects, such as any single aspect or any combination of aspects described below and/or in connection with one or more other processes described elsewhere herein.

In a first aspect, the DCI corresponds to a downlink DCI format 1_1 or a downlink DCI format 0_1. In a second aspect, alone or in combination with the first aspect, the DCI is scrambled by a C-RNTI, a CS-RNTI, or an MCS-RNTI. In a third aspect, alone or in combination with one or more of the first and second aspects, the DFI field comprises a DFI flag field and a HARQ-ACK bitmap. In a fourth aspect, alone or in combination with the third aspect, any bit not associated with either the DFI field or the HARQ-ACK bitmap is set to 0. In a fifth aspect, alone or in combination with one or more of the third or fourth aspects, the DCI corresponds to a downlink DCI format, and wherein the HARQ-ACK bitmap comprises 16 bits or 32 bits.

In a sixth aspect, alone or in combination with one or more of the third through fifth aspects, process 800 includes transmitting UE capability information indicative of a bitmap capability, wherein the HARQ-ACK bitmap comprises 16 bits or 32 bits based on the UE capability. In a seventh aspect, alone or in combination with the third aspect, the DCI corresponds to an uplink DCI format, and wherein the HARQ-ACK bitmap comprises 16 bits.

In an eighth aspect, alone or in combination with one or more of the third or seventh aspects, an order associated with a mapping between a plurality of bits of the HARQ-ACK bitmap and a plurality of HARQ process indices comprises an ascending order from a most significant bit of the bitmap to a least significant bit of the bitmap. In a ninth aspect, alone or in combination with one or more of the third, seventh, or eighth aspects, the DFI flag field comprises a first value, and wherein a bit of the HARQ-ACK bitmap that indicates the first value is indicative of an acknowledgement. In a tenth aspect, alone or in combination with the ninth aspect, whether to perform the HARQ retransmission operation corresponds to the bit of the HARQ-ACK bitmap.

In an eleventh aspect, alone or in combination with one or more of the first through tenth aspects, terminating the HARQ re-transmission operation comprises ending a HARQ re-transmission timer. In a twelfth aspect, alone or in combination with one or more of the first through eleventh aspects, terminating the HARQ retransmission operation comprises flushing a HARQ buffer corresponding to the HARQ re-transmission operation. In a thirteenth aspect, alone or in combination with one or more of the first through twelfth aspects, process 800 includes receiving configuration information indicative of the DFI field.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 604) performs operations associated with early termination of a HARQ re-transmission.

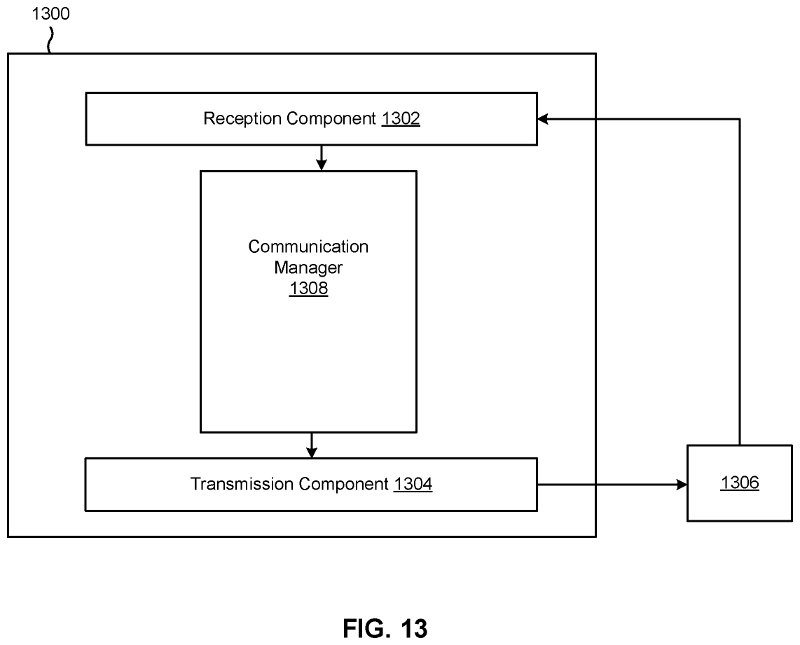

As shown in FIG. 9, in some aspects, process 900 may include transmitting configuration information indicative of a DFI field of a DCI format (block 910). For example, the network node (e.g., using communication manager 1308 and/or transmission component 1304, depicted in FIG. 13) may transmit configuration information indicative of a DFI field of a DCI format, as described above.

As further shown in FIG. 9, in some aspects, process 900 may include transmitting DCI corresponding to the DCI format, wherein the DCI comprises the DFI field, wherein the DFI field is indicative of at least one DFI value indicating that a UE is to terminate a HARQ re-transmission operation associated with a DRX cycle, wherein the configuration information indicates that the UE is to transition from a first state to a second state based on termination of the HARQ re-transmission operation, wherein the second state comprises a power-saving state (block 920). For example, the network node (e.g., using communication manager 1308 and/or transmission component 1304, depicted in FIG. 13) may transmit DCI corresponding to the DCI format, wherein the DCI comprises the DFI field, wherein the DFI field is indicative of at least one DFI value indicating that a UE is to terminate a HARQ re-transmission operation associated with a DRX cycle, wherein the configuration information indicates that the UE is to transition from a first state to a second state based on termination of the HARQ retransmission operation, wherein the second state comprises a power-saving state, as described above.

Process 900 may include additional aspects, such as any single aspect or any combination of aspects described below and/or in connection with one or more other processes described elsewhere herein.

In a first aspect, the DCI corresponds to a downlink DCI format 1_1 or a downlink DCI format 0_1. In a second aspect, alone or in combination with the first aspect, the DCI is scrambled by a C-RNTI, a CS-RNTI, or an MCS-RNTI. In a third aspect, alone or in combination with one or more of the first and second aspects, the DFI field comprises a DFI flag field and a HARQ-ACK bitmap. In a fourth aspect, alone or in combination with the third aspect, any bit not associated with either the DFI field or the HARQ-ACK bitmap is set to 0.

In a fifth aspect, alone or in combination with one or more of the third or fourth aspects, the DCI corresponds to a downlink DCI format, and wherein the HARQ-ACK bitmap comprises 16 bits or 32 bits. In a sixth aspect, alone or in combination with one or more of the third through fifth aspects, process 900 includes receiving UE capability information indicative of a bitmap capability, wherein the HARQ-ACK bitmap comprises 16 bits or 32 bits based on the bitmap capability. In a seventh aspect, alone or in combination with the third aspect, the DCI corresponds to an uplink DCI format, and wherein the HARQ-ACK bitmap comprises 16 bits.

In an eighth aspect, alone or in combination with one or more of the third or seventh aspects, an order associated with a mapping between a plurality of bits of the HARQ-ACK bitmap and a plurality of HARQ process indices comprises an ascending order from a most significant bit of the bitmap to a least significant bit of the bitmap. In a ninth aspect, alone or in combination with one or more of the third, seventh, or eighth aspects, the DFI flag field comprises a first value, and wherein a bit of the HARQ-ACK bitmap that indicates the first value is indicative of an acknowledgement. In a tenth aspect, alone or in combination with the ninth aspect, whether to perform the HARQ retransmission operation corresponds to the bit of the HARQ-ACK bitmap.

In an eleventh aspect, alone or in combination with one or more of the first through tenth aspects, termination of the HARQ re-transmission operation comprises an ending of a HARQ re-transmission timer. In a twelfth aspect, alone or in combination with one or more of the first through eleventh aspects, termination of the HARQ retransmission operation comprises a flushing operation associated with a HARQ buffer corresponding to the HARQ re-transmission operation. In a thirteenth aspect, alone or in combination with one or more of the first through twelfth aspects, process 900 includes transmitting configuration information indicative of the DFI field.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manager 1008.

In some aspects, the apparatus 1000 may be configured to perform one or more operations described herein in connection with FIGS. 6-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

In some examples, means for transmitting, outputting, or sending (or means for outputting for transmission) may include one or more antennas, a modulator, a transmit MIMO processor, a transmit processor, or a combination thereof, of the UE described above in connection with FIG. 2.

In some examples, means for receiving (or means for obtaining) may include one or more antennas, a demodulator, a MIMO detector, a receive processor, or a combination thereof, of the UE described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for transitioning and/or terminating may include various processing system components, such as a receive processor, a transmit processor, a controller/processor, a memory, or a combination thereof, of the UE described above in connection with FIG. 2.

The communication manager 1008 and/or the reception component 1002 may receive DCI comprising a DFI field indicative of at least one DFI value. In some aspects, the communication manager 1008 may include one or more antennas, a modem, a controller/processor, a memory, or a combination thereof, of the UE described in connection with FIG. 2. In some aspects, the communication manager 1008 may include the reception component 1002 and/or the transmission component 1004. In some aspects, the communication manager 1008 may be, be similar to, include, or be included in, the communication manager 140 depicted in FIGS. 1 and 2.

The communication manager 1008, the reception component 1002, and/or the transmission component 1004 may terminate a HARQ re-transmission operation associated with a DRX cycle based on receiving the DCI. The communication manager 1008, the reception component 1002, and/or the transmission component 1004 may transition from a first state to a second state based on terminating the HARQ retransmission operation, wherein the second state comprises a power-saving state. The communication manager 1008 and/or the transmission component 1004 may transmit UE capability information indicative of a bitmap capability, wherein the HARQ-ACK bitmap comprises 16 bits or 32 bits based on the bitmap capability. The communication manager 1008 and/or reception component 1002 may receive configuration information indicative of the DFI field.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

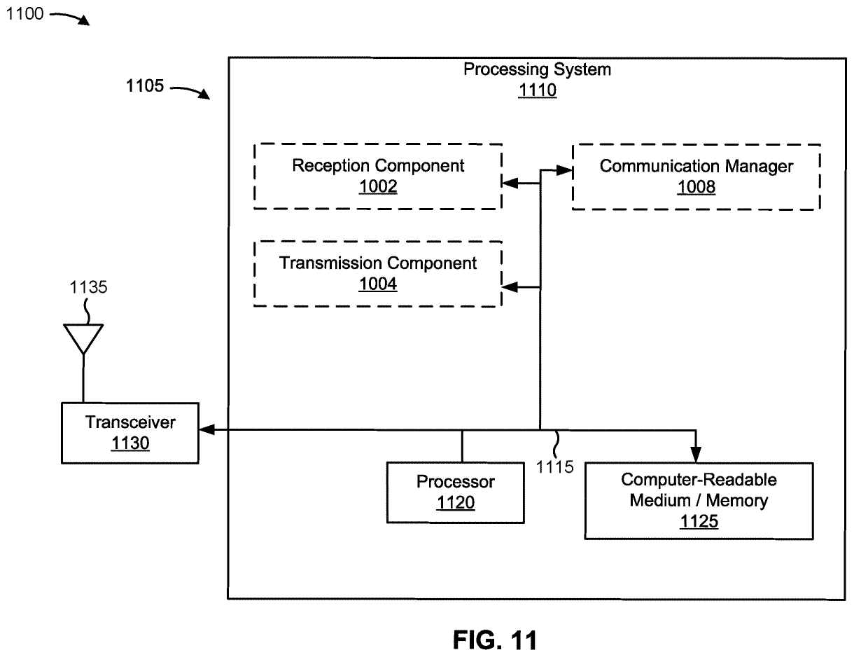

FIG. 11 is a diagram illustrating an example 1100 of a hardware implementation for an apparatus 1105 employing a processing system 1110, in accordance with the present disclosure. The apparatus 1105 may be a UE.

The processing system 1110 may be implemented with a bus architecture, represented generally by the bus 1115. The bus 1115 may include any number of interconnecting buses and bridges depending on the specific application of the processing system 1110 and the overall design constraints. The bus 1115 links together various circuits including one or more processors and/or hardware components, represented by the processor 1120, the illustrated components, and the computer-readable medium/memory 1125. The bus 1115 may also link various other circuits, such as timing sources, peripherals, voltage regulators, and/or power management circuits.

The processing system 1110 may be coupled to a transceiver 1130. The transceiver 1130 is coupled to one or more antennas 1135. The transceiver 1130 provides a means for communicating with various other apparatuses over a transmission medium. The transceiver 1130 receives a signal from the one or more antennas 1135, extracts information from the received signal, and provides the extracted information to the processing system 1110, specifically the reception component 1002. In addition, the transceiver 1130 receives information from the processing system 1110, specifically the transmission component 1004, and generates a signal to be applied to the one or more antennas 1135 based at least in part on the received information.

The processing system 1110 includes a processor 1120 coupled to a computer-readable medium/memory 1125. The processor 1120 is responsible for general processing, including the execution of software stored on the computer-readable medium/memory 1125. The software, when executed by the processor 1120, causes the processing system 1110 to perform the various functions described herein for any particular apparatus. The computer-readable medium/memory 1125 may also be used for storing data that is manipulated by the processor 1120 when executing software.

The processing system further includes at least one of the illustrated components. The components may be software modules running in the processor 1120, resident/stored in the computer readable medium/memory 1125, one or more hardware modules coupled to the processor 1120, or some combination thereof.

In some aspects, the processing system 1110 may be a component of the UE 120 and may include the memory 282 and/or at least one of the TX MIMO processor 266, the RX processor 258, and/or the controller/processor 280. In some aspects, the apparatus 1105 for wireless communication includes means for receiving DCI comprising a DFI field indicative of at least one DFI value; terminating a HARQ retransmission operation associated with a DRX cycle based on receiving the DCI; and transitioning from a first state to a second state based on terminating the HARQ retransmission operation, wherein the second state comprises a power-saving state. The aforementioned means may be one or more of the aforementioned components of the apparatus 1200 and/or the processing system 1110 of the apparatus 1105 configured to perform the functions recited by the aforementioned means. As described elsewhere herein, the processing system 1110 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 11 is provided as an example. Other examples may differ from what is described in connection with FIG. 11.

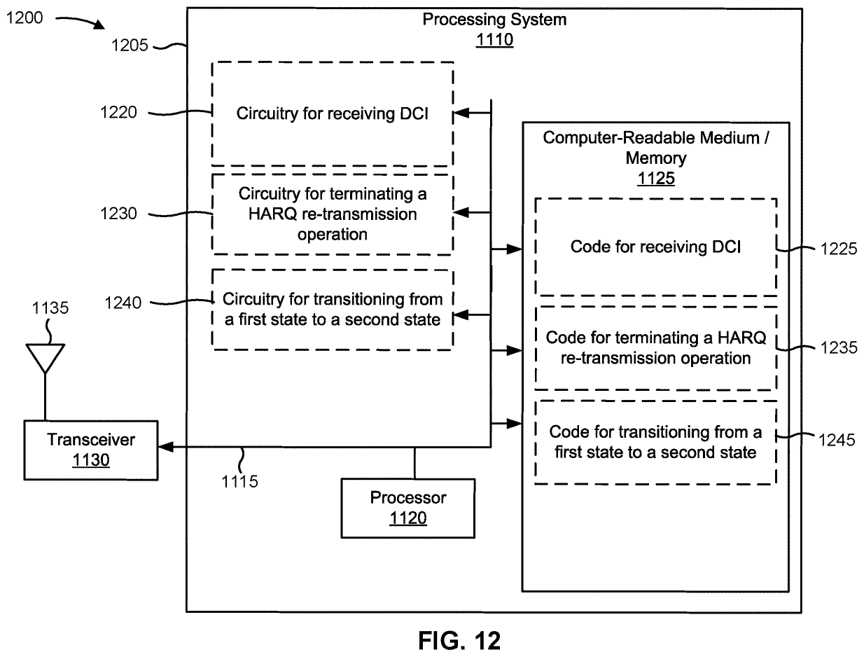

FIG. 12 is a diagram illustrating an example 1200 of an implementation of code and circuitry for an apparatus 1205, in accordance with the present disclosure. The apparatus 1205 may be a UE, or a UE may include the apparatus 1205.

As shown in FIG. 12, the apparatus 1205 may include circuitry for receiving DCI (circuitry 1220). For example, the circuitry 1220 may enable the apparatus 1205 to receive DCI comprising a DFI field indicative of at least one DFI value.

As shown in FIG. 12, the apparatus 1205 may include, stored in computer-readable medium 1125, code for receiving DCI (code 1225). For example, the code 1225, when executed by processor 1120, may cause processor 1120 to cause transceiver 1130 to receive DCI comprising a DFI field indicative of at least one DFI value.

As shown in FIG. 12, the apparatus 1205 may include circuitry for terminating a HARQ re-transmission operation (circuitry 1230). For example, the circuitry 1230 may enable the apparatus 1205 to terminate a HARQ re-transmission operation associated with a DRX cycle based on receiving the DCI.

As shown in FIG. 12, the apparatus 1205 may include, stored in computer-readable medium 1125, code for terminating a HARQ re-transmission operation (code 1235). For example, the code 1235, when executed by processor 1120, may cause processor 1120 to terminate a HARQ re-transmission operation associated with a DRX cycle based on receiving the DCI.

As shown in FIG. 12, the apparatus 1205 may include circuitry for transitioning from a first state to a second state (circuitry 1240). For example, the circuitry 1240 may enable the apparatus 1205 to transition from a first state to a second state based on terminating the HARQ re-transmission operation, wherein the second state comprises a power-saving state.

As shown in FIG. 12, the apparatus 1205 may include, stored in computer-readable medium 1125, code for transitioning from a first state to a second state (code 1245). For example, the code 1245, when executed by processor 1120, may cause processor 1120 to transition from a first state to a second state based on terminating the HARQ re-transmission operation, wherein the second state comprises a power-saving state.

FIG. 12 is provided as an example. Other examples may differ from what is described in connection with FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a communication manager 1308.

In some aspects, the apparatus 1300 may be configured to perform one or more operations described herein in connection with FIGS. 6-7. Additionally, or alternatively, the apparatus 1300 may be configured to perform one or more processes described herein, such as process 900 of FIG. 9. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

In some examples, means for transmitting, outputting, or sending (or means for outputting for transmission) may include one or more antennas, a modulator, a transmit MIMO processor, a transmit processor, or a combination thereof, of the network node described above in connection with FIG. 2.

In some examples, means for receiving (or means for obtaining) may include one or more antennas, a demodulator, a MIMO detector, a receive processor, or a combination thereof, of the network node described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for determining, receiving, and/or transmitting may include various processing system components, such as a receive processor, a transmit processor, a controller/processor, a memory, or a combination thereof, of the network node described above in connection with FIG. 2.

The communication manager 1308 and/or the transmission component 1304 may transmit configuration information indicative of a DFI field of a DCI format. In some aspects, the communication manager 1308 may include one or more antennas, a modem, a controller/processor, a memory, or a combination thereof, of the network node described in connection with FIG. 2. In some aspects, the communication manager 1308 may include the reception component 1302 and/or the transmission component 1304. In some aspects, the communication manager 1308 may be, be similar to, include, or be included in, the communication manager 130 depicted in FIGS. 1 and 2.

The communication manager 1308 and/or the transmission component 1304 may transmit DCI corresponding to the DCI format, wherein the DCI comprises the DFI field, wherein the DFI field is indicative of at least one DFI value indicating that a UE is to terminate a HARQ re-transmission operation associated with a DRX cycle, wherein the configuration information indicates that the UE is to transition from a first state to a second state based on termination of the HARQ re-transmission operation, wherein the second state comprises a power-saving state.

The communication manager 1308 and/or the reception component 1302 may receive UE capability information indicative of a bitmap capability, wherein the HARQ-ACK bitmap comprises 16 bits or 32 bits based on the bitmap capability. The communication manager 1308 and/or the transmission component 1304 may transmit configuration information indicative of the DFI field.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

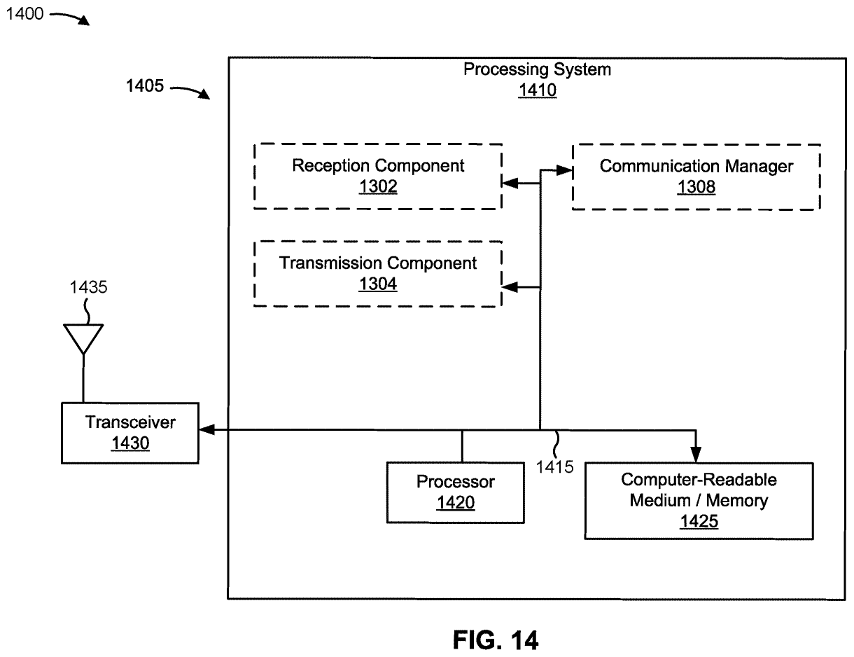

FIG. 14 is a diagram illustrating an example 1400 of a hardware implementation for an apparatus 1405 employing a processing system 1410, in accordance with the present disclosure. The apparatus 1405 may be a network node.

The processing system 1410 may be implemented with a bus architecture, represented generally by the bus 1415. The bus 1415 may include any number of interconnecting buses and bridges depending on the specific application of the processing system 1410 and the overall design constraints. The bus 1415 links together various circuits including one or more processors and/or hardware components, represented by the processor 1420, the illustrated components, and the computer-readable medium/memory 1425. The bus 1415 may also link various other circuits, such as timing sources, peripherals, voltage regulators, and/or power management circuits.

The processing system 1410 may be coupled to a transceiver 1430. The transceiver 1430 is coupled to one or more antennas 1435. The transceiver 1430 provides a means for communicating with various other apparatuses over a transmission medium. The transceiver 1430 receives a signal from the one or more antennas 1435, extracts information from the received signal, and provides the extracted information to the processing system 1410, specifically the reception component 1302. In addition, the transceiver 1430 receives information from the processing system 1410, specifically the transmission component 1304, and generates a signal to be applied to the one or more antennas 1435 based at least in part on the received information.

The processing system 1410 includes a processor 1420 coupled to a computer-readable medium/memory 1425. The processor 1420 is responsible for general processing, including the execution of software stored on the computer-readable medium/memory 1425. The software, when executed by the processor 1420, causes the processing system 1410 to perform the various functions described herein for any particular apparatus. The computer-readable medium/memory 1425 may also be used for storing data that is manipulated by the processor 1420 when executing software.

The processing system further includes at least one of the illustrated components. The components may be software modules running in the processor 1420, resident/stored in the computer readable medium/memory 1425, one or more hardware modules coupled to the processor 1420, or some combination thereof.

In some aspects, the processing system 1410 may be a component of the base station 110 and may include the memory 242 and/or at least one of the TX MIMO processor 230, the RX processor 238, and/or the controller/processor 240. In some aspects, the apparatus 1405 for wireless communication includes means for transmitting configuration information indicative of a DFI field of a DCI format; and transmitting DCI corresponding to the DCI format, wherein the DCI comprises the DFI field, wherein the DFI field is indicative of at least one DFI value indicating that a UE is to terminate a HARQ re-transmission operation associated with a discontinuous reception cycle, wherein the configuration information indicates that the UE is to transition from a first state to a second state based on termination of the HARQ re-transmission operation, wherein the second state comprises a power-saving state. The aforementioned means may be one or more of the aforementioned components of the apparatus 1500 and/or the processing system 1410 of the apparatus 1405 configured to perform the functions recited by the aforementioned means. As described elsewhere herein, the processing system 1410 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 14 is provided as an example. Other examples may differ from what is described in connection with FIG. 14.

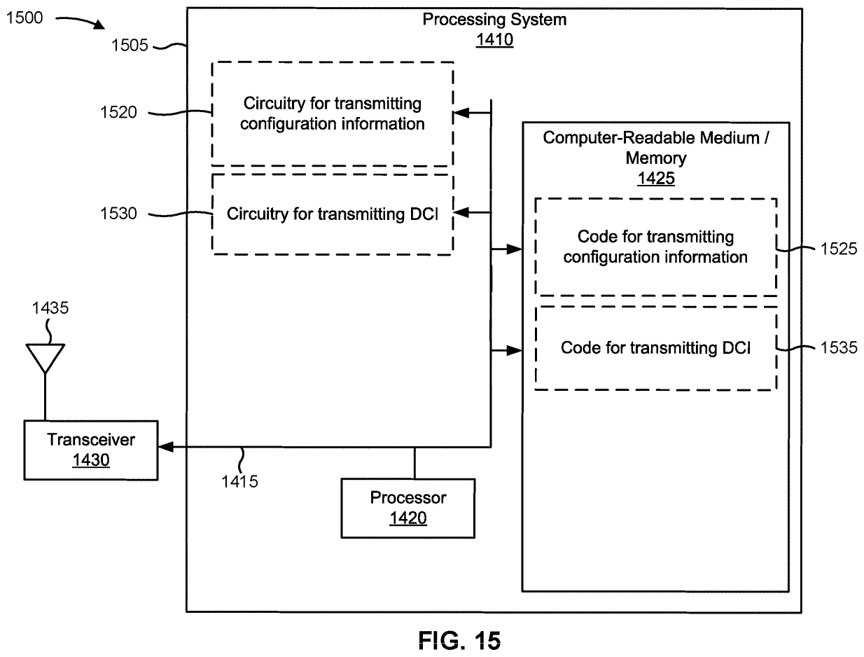

FIG. 15 is a diagram illustrating an example 1500 of an implementation of code and circuitry for an apparatus 1505, in accordance with the present disclosure. The apparatus 1505 may be a network node, or a network node may include the apparatus 1505.

As shown in FIG. 15, the apparatus 1505 may include circuitry for transmitting configuration information (circuitry 1520). For example, the circuitry 1520 may enable the apparatus 1505 to transmit configuration information indicative of a DFI field of a DCI format.

As shown in FIG. 15, the apparatus 1505 may include, stored in computer-readable medium 1425, code for transmitting configuration information (code 1525).

For example, the code 1525, when executed by processor 1420, may cause processor 1420 to cause transceiver 1430 to transmit configuration information indicative of a DFI field of a DCI format.

As shown in FIG. 15, the apparatus 1505 may include circuitry for transmitting DCI (circuitry 1530). For example, the circuitry 1530 may enable the apparatus 1505 to transmit DCI corresponding to the DCI format, wherein the DCI comprises the DFI field, wherein the DFI field is indicative of at least one DFI value indicating that a UE is to terminate a HARQ re-transmission operation associated with a DRX cycle, wherein the configuration information indicates that the UE is to transition from a first state to a second state based on termination of the HARQ re-transmission operation, wherein the second state comprises a power-saving state.

As shown in FIG. 15, the apparatus 1505 may include, stored in computer-readable medium 1425, code for transmitting DCI (code 1535). For example, the code 1535, when executed by processor 1420, may cause processor 1420 to cause transceiver 1430 to transmit DCI corresponding to the DCI format, wherein the DCI comprises the DFI field, wherein the DFI field is indicative of at least one DFI value indicating that a UE is to terminate a HARQ re-transmission operation associated with a DRX cycle, wherein the configuration information indicates that the UE is to transition from a first state to a second state based on termination of the HARQ re-transmission operation, wherein the second state comprises a power-saving state.

FIG. 15 is provided as an example. Other examples may differ from what is described in connection with FIG. 15.

The following provides an overview of some Aspects of the present disclosure:
Aspect 1: A method of wireless communication performed by an apparatus of a user equipment (UE), comprising: receiving downlink control information (DCI) comprising a downlink feedback indicator (DFI) field indicative of at least one DFI value; terminating a hybrid automatic repeat request (HARQ) re-transmission operation associated with a discontinuous reception cycle based on receiving the DCI; and transitioning from a first state to a second state based on terminating the HARQ retransmission operation, wherein the second state comprises a power-saving state.
Aspect 2: The method of Aspect 1, wherein the DCI corresponds to a downlink DCI format 1_1 or a downlink DCI format 0_1.
Aspect 3: The method of either of Aspects 1 or 2, wherein the DCI is scrambled by a cell radio network temporary identifier (RNTI), a configured scheduling RNTI, or a modulation and coding scheme RNTI.
Aspect 4: The method of any of Aspects 1-3, wherein the DFI field comprises a DFI flag field and a HARQ-acknowledgment (HARQ-ACK) bitmap.
Aspect 5: The method of Aspect 4, wherein any bit not associated with either the DFI field or the HARQ-ACK bitmap is set to 0.
Aspect 6: The method of either of Aspects 4 or 5, wherein the DCI corresponds to a downlink DCI format, and wherein the HARQ-ACK bitmap comprises 16 bits or 32 bits.
Aspect 7: The method of any of Aspects 4-6, further comprising transmitting UE capability information indicative of a bitmap capability, wherein the HARQ-ACK bitmap comprises 16 bits or 32 bits based on the bitmap capability.
Aspect 8: The method of Aspect 4, wherein the DCI corresponds to an uplink DCI format, and wherein the HARQ-ACK bitmap comprises 16 bits.
Aspect 9: The method of either of Aspects 4 or 8, wherein an order associated with a mapping between a plurality of bits of the HARQ-ACK bitmap and a plurality of HARQ process indices comprises an ascending order from a most significant bit of the bitmap to a least significant bit of the bitmap.
Aspect 10: The method of any of Aspects 4, 8, or 9, wherein the DFI flag field comprises a first value, and wherein a bit of the HARQ-ACK bitmap that indicates the first value is indicative of an acknowledgement.
Aspect 11: The method of Aspect 10, wherein whether to perform the HARQ re-transmission operation corresponds to the bit of the HARQ-ACK bitmap.
Aspect 12: The method of any of Aspects 1-11, wherein terminating the HARQ re-transmission operation comprises ending a HARQ re-transmission timer.
Aspect 13: The method of any of Aspects 1-11, wherein terminating the HARQ re-transmission operation comprises flushing a HARQ buffer corresponding to the HARQ re-transmission operation.
Aspect 14: The method of any of Aspects 1-11, further comprising receiving configuration information indicative of the DFI field.
Aspect 15: A method of wireless communication performed by an apparatus of a network node, comprising: transmitting configuration information indicative of a downlink feedback indicator (DFI) field of a downlink control information (DCI) format; and transmitting DCI corresponding to the DCI format, wherein the DCI comprises the DFI field, wherein the DFI field is indicative of at least one DFI value indicating that a user equipment (UE) is to terminate a hybrid automatic repeat request (HARQ) re-transmission operation associated with a discontinuous reception cycle, wherein the configuration information indicates that the UE is to transition from a first state to a second state based on termination of the HARQ re-transmission operation, wherein the second state comprises a power-saving state.
Aspect 16: The method of Aspect 15, wherein the DCI corresponds to a downlink DCI format 1_1 or a downlink DCI format 0_1.
Aspect 17: The method of either of Aspects 15 or 16, wherein the DCI is scrambled by a cell radio network temporary identifier (RNTI), a configured scheduling RNTI, or a modulation and coding scheme RNTI.
Aspect 18: The method of any of Aspects 15-17, wherein the DFI field comprises a DFI flag field and a HARQ-acknowledgment (HARQ-ACK) bitmap.
Aspect 19: The method of Aspect 18, wherein any bit not associated with either the DFI field or the HARQ-ACK bitmap is set to 0.
Aspect 20: The method of either of Aspects 18 or 19, wherein the DCI corresponds to a downlink DCI format, and wherein the HARQ-ACK bitmap comprises 16 bits or 32 bits.
Aspect 21: The method of any of Aspects 18-20, further comprising receiving UE capability information indicative of a bitmap capability, wherein the HARQ-ACK bitmap comprises 16 bits or 32 bits based on the bitmap capability.
Aspect 22: The method of Aspect 18, wherein the DCI corresponds to an uplink DCI format, and wherein the HARQ-ACK bitmap comprises 16 bits.
Aspect 23: The method of either of Aspects 18 or 22, wherein an order associated with a mapping between a plurality of bits of the HARQ-ACK bitmap and a plurality of HARQ process indices comprises an ascending order from a most significant bit of the bitmap to a least significant bit of the bitmap.
Aspect 24: The method of any of Aspects 18, 22, or 23, wherein the DFI flag field comprises a first value, and wherein a bit of the HARQ-ACK bitmap that indicates the first value is indicative of an acknowledgement.
Aspect 25: The method of Aspect 24, wherein whether to perform the HARQ re-transmission operation corresponds to the bit of the HARQ-ACK bitmap.
Aspect 26: The method of any of Aspects 15-25, wherein termination of the HARQ re-transmission operation comprises an ending of a HARQ re-transmission timer.
Aspect 27: The method of any of Aspects 15-26, wherein termination of the HARQ re-transmission operation comprises a flushing operation associated with a HARQ buffer corresponding to the HARQ re-transmission operation.
Aspect 28: The method of any of Aspects 15-27, further comprising transmitting configuration information indicative of the DFI field.
Aspect 29: An apparatus for wireless communication at a device, comprising a processor; memory coupled with the processor, and instructions stored in the memory and executable by the processor to cause the apparatus to perform the method of one or more of Aspects 1-14.
Aspect 30: A device for wireless communication, comprising a memory and one or more processors coupled to the memory, the one or more processors configured to perform the method of one or more of Aspects 1-14.
Aspect 31: An apparatus for wireless communication, comprising at least one means for performing the method of one or more of Aspects 1-14.
Aspect 32: A non-transitory computer-readable medium storing code for wireless communication, the code comprising instructions executable by a processor to perform the method of one or more of Aspects 1-14.
Aspect 33: A non-transitory computer-readable medium storing a set of instructions for wireless communication, the set of instructions comprising one or more instructions that, when executed by one or more processors of a device, cause the device to perform the method of one or more of Aspects 1-14.
Aspect 34: An apparatus for wireless communication at a device, comprising a processor; memory coupled with the processor, and instructions stored in the memory and executable by the processor to cause the apparatus to perform the method of one or more of Aspects 15-28.
Aspect 35: A device for wireless communication, comprising a memory and one or more processors coupled to the memory, the one or more processors configured to perform the method of one or more of Aspects 15-28.
Aspect 36: An apparatus for wireless communication, comprising at least one means for performing the method of one or more of Aspects 15-28.
Aspect 37: A non-transitory computer-readable medium storing code for wireless communication, the code comprising instructions executable by a processor to perform the method of one or more of Aspects 15-28.
Aspect 38: A non-transitory computer-readable medium storing a set of instructions for wireless communication, the set of instructions comprising one or more instructions that, when executed by one or more processors of a device, cause the device to perform the method of one or more of Aspects 15-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors coupled to the memory, the one or more processors configured to:
obtain downlink control information (DCI) comprising a downlink feedback indicator (DFI) field indicative of at least one DFI value;
terminate a hybrid automatic repeat request (HARQ) re-transmission operation associated with a discontinuous reception cycle based on receiving the DCI; and
transition from a first state to a second state based on terminating the HARQ re-transmission operation, wherein the second state comprises a power-saving state.

2. The UE of claim 1, wherein the DCI corresponds to a downlink DCI format 1_1 or a downlink DCI format 0_1.

3. The UE of claim 1, wherein the DCI is scrambled by a cell radio network temporary identifier (RNTI), a configured scheduling RNTI, or a modulation and coding scheme RNTI.

4. The UE of claim 1, wherein the DFI field comprises a DFI flag field and a HARQ-acknowledgment (HARQ-ACK) bitmap.

5. The UE of claim 4, wherein any bit not associated with either the DFI field or the HARQ-ACK bitmap is set to 0.

6. The UE of claim 4, wherein the DCI corresponds to a downlink DCI format, and wherein the HARQ-ACK bitmap comprises 16 bits or 32 bits.

7. The UE of claim 4, wherein the one or more processors are further configured to output for transmission UE capability information indicative of a bitmap capability, wherein the HARQ-ACK bitmap comprises 16 bits or 32 bits based on the bitmap capability.

8. The UE of claim 4, wherein the DCI corresponds to an uplink DCI format, and wherein the HARQ-ACK bitmap comprises 16 bits.

9. The UE of claim 4, wherein an order associated with a mapping between a plurality of bits of the HARQ-ACK bitmap and a plurality of HARQ process indices comprises an ascending order from a most significant bit of the bitmap to a least significant bit of the bitmap.

10. The UE of claim 4, wherein the DFI flag field comprises a first value, and wherein a bit of the HARQ-ACK bitmap that indicates the first value is indicative of an acknowledgement.

11. The UE of claim 10, wherein whether to perform the HARQ re-transmission operation corresponds to the bit of the HARQ-ACK bitmap.

12. The UE of claim 1, wherein the one or more processors, to terminate the HARQ re-transmission operation, are configured to end a HARQ re-transmission timer.

13. The UE of claim 1, wherein the one or more processors, to terminate the HARQ re-transmission operation, are configured to flush a HARQ buffer corresponding to the HARQ re-transmission operation.

14. The UE of claim 1, wherein the one or more processors are further configured to obtain configuration information indicative of the DFI field.

15. A network node for wireless communication, comprising:
a memory; and
one or more processors coupled to the memory, the one or more processors configured to:
output for transmission configuration information indicative of a downlink feedback indicator (DFI) field of a downlink control information (DCI) format; and
output for transmission DCI corresponding to the DCI format, wherein the DCI comprises the DFI field, wherein the DFI field is indicative of at least one DFI value indicating that a user equipment (UE) is to terminate a hybrid automatic repeat request (HARQ) re-transmission operation associated with a discontinuous reception cycle, wherein the configuration information indicates that the UE is to transition from a first state to a second state based on termination of the HARQ re-transmission operation, wherein the second state comprises a power-saving state.

16. The network node of claim 15, wherein the DCI corresponds to a downlink DCI format 1_1 or a downlink DCI format 0_1.

17. The network node of claim 15, wherein the DCI is scrambled by a cell radio network temporary identifier (RNTI), a configured scheduling RNTI, or a modulation and coding scheme RNTI.

18. The network node of claim 15, wherein the DFI field comprises a DFI flag field and a HARQ-acknowledgment (HARQ-ACK) bitmap.

19. A method of wireless communication performed by an apparatus at a user equipment (UE), comprising:
receiving downlink control information (DCI) comprising a downlink feedback indicator (DFI) field indicative of at least one DFI value;
terminating a hybrid automatic repeat request (HARQ) re-transmission operation associated with a discontinuous reception cycle based on receiving the DCI; and
transitioning from a first state to a second state based on terminating the HARQ re-transmission operation, wherein the second state comprises a power-saving state.

20. The method of claim 19, wherein the DCI corresponds to a downlink DCI format 1_1 or a downlink DCI format 0_1.
